(19) United States
(12) Patent Application Publication
(10) Pub. No.: US 2011/0320284 A1
(43) Pub. Date: Dec. 29, 2011

(54) Market for Social Promotion of Digital Goods

(75) Inventors: Moshe Tennenholtz, Haifa (IL); Ron Karidi, Herzeliya (IL); Roy VARSHVSKY, Tel Aviv (IL); Ran MOKADY, Kiryat Ono (IL); Yuval EMEK, Tel Aviv (IL); Kira RADINSKY, Zichron Yaacov (IL)

(73) Assignee: MICROSOFT CORPORATION, Redmond, WA (US)

(21) Appl. No.: 12/823,122

(22) Filed: Jun. 25, 2010

(51) Int. Cl. G06Q 30/00; G06Q 99/00; G06N 5/02

(52) U.S. Cl. 705/14.69; 706/52; 705/14.4

(57) ABSTRACT

A social network marketplace may monitor communications between an advertiser and a consumer by generating signatures for communications and tracking those signatures through social network communications until a sale may be consummated. The marketplace may monitor the transactions to determine a user's influence on other users. A user's influence may also be determined or supplemented by monitoring formal or informal social interactions performed on a computer when those communications are able to be monitored. The influence information may be used to select outbound advertisements to those users who may benefit from an advertisement, as well as to filter inbound advertisements to suit a user or a user's situation.

### BACKGROUND

Social networks are built on relationships between people. The relationships may reflect some degree of trust or interest between the participants, and are a time-honored way for people to share information about products that they purchase.

Social networks have existed since the dawn of time among humans. In some cases, social networks may be formal networks, such as fraternities and sororities, country clubs, or professional organizations. In other cases, social networks may be less formal, such as neighbors, acquaintances from a job, or people that may meet at a restaurant or bar.

Computers have facilitated social networks in similar forms. Some social networks have formal relationships where one or both parties in the relationship may declare a ‘friend’ status with the other party. In some computer-facilitated social networks, the relationships may be less formally established. For example, a first user may store email contact information about a second user in a contacts database, or a user may periodically visit another user's weblog.

### SUMMARY

A social network marketplace may monitor communications between an advertiser and a consumer by generating signatures for communications and tracking those signatures through social network communications until a sale may be consummated. The marketplace may monitor the transactions to determine a user's influence on other users. A user's influence may also be determined or supplemented by monitoring formal or informal social interactions performed on a computer when those communications are able to be monitored. The influence information may be used to select outbound advertisements to those users who may benefit from an advertisement, as well as to filter inbound advertisements to suit a user or a user's situation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a social network and marketplace in a network setting.

FIG. 2 is a diagram illustration of an embodiment showing interactions during an advertisement and purchase.

FIG. 3 is a timeline illustration of an embodiment showing a method for advertising and purchasing a product.

FIG. 4 is a flowchart illustration of an embodiment showing a method for ranking and filtering using influence information.

### DETAILED DESCRIPTION

A social marketplace system may facilitate and monitor marketing transactions. The marketplace system may be used with many different social network systems, both formal and informal, and may facilitate and track communications between people. In some cases, those people who share advertisements with other people may be given rewards, including monetary rewards, for sharing.

The marketplace system may develop and update influence statistics or data on the various users. The influence data may be used to direct advertisements to those users who may be best suited to generate revenue from the advertisements, either because the users are likely consumers or because the users may be likely to re-transmit the advertisements.

The influence data may also be used to filter or limit advertisements received by a user. Rather than bombarding a user with advertisements, the marketplace system may reduce the advertisements to those which are relevant to the user's situation and are from sources that the user may trust, as determined by the influence data.

The marketplace system may operate as a backend system to one or more social networks and may allow advertisements to cross from one social network to another and still be tracked. Multiple types of computer-based social networks may interface with the marketplace, including formal and informal social networks, and the marketplace system may be independent of any specific social network.

The marketplace system may gather influence data based on user's interactions within different types of social networks. Some social networks may be publically accessible and may be readily monitored and analyzed, while other social networks may have varying degrees of privacy or access restrictions. In some cases, a marketplace system may access a social network after a user has given permission to monitor the user's actions.

The term ‘social network’ as used in this specification and claims refers to any type of computer-assisted communication mechanism by which users may interact. In some cases, a social network may be a website where each user may update their status, post pictures, and share information with other users. Such a social network may be considered a formal or structured social network where the interactions are defined by the social network application.

In some embodiments, a social network may have formal procedures for establishing relationships between users. For example, a first user may invite a second user into a relationship and the social network system may establish a relationship between the users. Some social networks may establish such relationships at the request of the first user, while other social networks may establish such relationships after the second user approves the relationship.

Some social networks may limit communications to users with whom relationships are already established. Such social networks may or may not permit access from other people who do not have previously established relationships. Other social networks may make some or all communications between users publically available.

A social network may not be formal application or website and may be considered an informal social network. For example, one form of a social network may be email or instant messaging systems. In a conventional email system, a user may maintain a list of email addresses and other contact information about other users. A user may create or forward email messages to one or many users and thus an email system may be considered a social network. Similarly, instant messaging systems may also be considered a social network.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

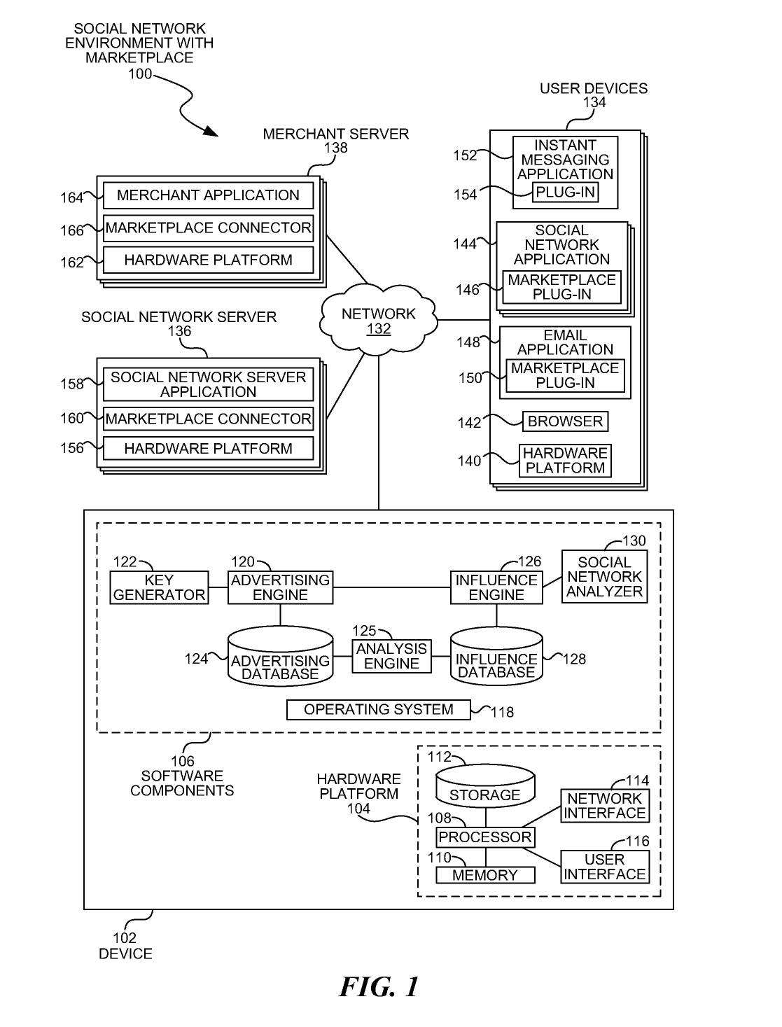

FIG. 1 is a diagram of an embodiment 100, showing a system with a marketplace for social network. Embodiment 100 is a simplified example of a network environment in which users may interact with social networks to access a marketplace.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 is an example of how a marketplace may be used in conjunction with social networks. The marketplace may track advertisements and purchases. The marketplace may also act as a filter to help users minimize unwanted or irrelevant advertisements, as well as identify those people who may be successful in marketing a product or service.

The marketplace may act as a central tracking mechanism where advertisements may be created with identifying keys associated with a user who creates the advertisements. When the advertisements are used to make a purchase or perform some other transaction, the marketplace may receive information about the transaction. The marketplace may be configured to pay a commission or give credit to the originator of the advertisement, for example.

Throughout this specification and claims, the term ‘advertisement’ may be any type of communication that may be traced by a marketplace system. In some cases, the advertisement may be an electronic document that may contain a request key or other identifier. The electronic document may be an email message, instant message, weblog posting, or other communication that may be transmitted in a social network. The term ‘advertisement’ is used in this specification and claims to refer to any type of message transmitted between users of a social network.

In some embodiments, an advertisement may be a link to a web page or other Uniform Resource Identifier (URI). When the advertisement is a web page or URI, the advertisement may be referenced in a posting on a social network, transmitted in an email or instant message, or sent using other methods.

The advertisement may be a solicitation for goods or services. In some cases, the goods or services may be digital goods or services, while in other cases, the goods and services may be physical goods and services. The advertisement may be a notice or other communication on any topic whatsoever.

In many cases, an advertisement may include a call to action. For example, a solicitation for goods or services may have a call to action to purchase. In another example, a political advertisement may have a call to action to sign a petition, vote on a topic, donate to a cause, or contact a legislator. In still another example, an advertisement for a social network game may have a call to action to have other game players join the game or participate in some manner.

When responding to a call to action, a communication may be sent to the marketplace so that the result of the advertisement may be recorded. The communication may be used to track the movement of the advertisement through a social network. In some cases, the marketplace may allocate credits to the originator of the advertisement, such as monetary credits or influence credits. Influence credits may be used to measure a user's influence within the social network.

In some cases, an advertisement may not include a call to action. In such embodiments, the social network communication system may send updates to the marketplace when an advertisement may be forwarded or otherwise transmitted between users of the social network. The marketplace may track the transmission of the advertisement between social network users.

In some embodiments, the marketplace may be configured for multilevel marketing or other types of social networking-based marketing schemes. In such embodiments, an original advertisement may be created by a seller and passed to several users. The users may engage the marketplace to create new advertisements that have new identifier keys and are linked to the original advertisement. The new advertisements may be passed to other users, who may in turn create new advertisements from the previous ones. Each time such a process occurs may be considered a generation in the life of the advertisement. The marketplace may track the various generations of advertisements as the advertisements as passed along the social networks.

The tracking provided by the marketplace may allow complex commission payments to be made. For example, a marketing campaign may pay a 2% commission to each person who forwards an advertisement to their friends or associates, and may pay such a commission for up to several generations of transmissions. In another example, the last person to transmit an advertisement to a user who makes a purchase may be paid a higher commission than previous generations of users. These examples merely show different commission schemes that the marketplace may enable. Other commission/credit schemes may be used as well.

The marketplace may determine an influence rating for various users. The influence rating may be used in several scenarios to improve the effectiveness of marketing campaigns as well as to minimize unwanted or irrelevant advertisements to users.

The influence rating may reflect a user's influence on other users. A user with a high influence rating may be more trusted than a user with a lower influence rating. A high influence rating may reflect a user's success in marketing products in the past, as well as the effectiveness of the user's social network.

One scenario for using an influence rating may be to filter or limit the advertisements received by a user. Depending on the type of social network a user may use, the social network may be configured to filter or rank advertisements prior to presenting the advertisements to a user. Advertisements received from highly influential users may be more relevant and useful from less influential users.

Another scenario for using an influence rating may be to identify those users who may be successful in getting the word out for a particular marketing campaign. For example, an advertiser may rank people to send a particular advertisement. Rather than sending the advertisement to as many people as possible, the advertiser may send the advertisement to a small group of people who may be more interested in the advertisement or who may be more successful in promoting the product.

Embodiment 100 illustrates a network environment in which a social network may operate and where a marketplace may also operate. Device 102 may represent a device on which the marketplace may operate.

The architecture illustrated for device 102 may represent a typical architecture with hardware and software components; however, other architectures may be used to operate a marketplace. For larger deployments, a marketplace may be implemented on a cluster of server computers or within a datacenter. Some such deployments may be implemented as virtual machines, cloud computing, or other types of computational platforms.

In embodiment 100, the hardware components 104 may include a processor 108, random access memory 110, and nonvolatile storage 112. The hardware components 104 may also include a network interface 114 and a user interface 116.

The software components 106 may include an operating system 118 on which various applications may execute, including an advertising engine 120 and influence engine 126.

The advertising engine 120 may track advertisements in an advertising database 124. A key generator 122 may generate keys that may be attached to an advertisement to identify a specific advertisement created by a specific user.

The advertising database 124 may contain records of specific advertisements and the users who created the advertisements and those users who responded to the advertisements. In some cases, the advertising database 124 may contain links to other advertisements when those advertisements are forwarded from one user to another.

The key generator 122 may generate identifying keys for advertisements. The identifying keys may be any type of indicator that may be used to track advertisements. In some embodiments, an identifying key may be a Globally Unique Identifier (GUID) or other sequence of characters. Some embodiments may use a URI that has an embedded serial number. Still other embodiments may issue sequential numbers as keys.

The identifying keys may be requested by a social network or other application through which an advertisement may be generated. The social network or application may transmit information about an advertisement to the advertising engine 120. The information may include the requesting user, as well as other metadata about an advertisement. The metadata may include a payment scheme for remitting commission moneys to the requesting user.

The metadata may also include an identifying key for another advertisement received by the requesting user. The other advertisement may be one which the requesting user may forward to other users within the user's social networks. In such a case, the advertisement database 124 may include chains or sequences of users associated with each time an advertisement may be forwarded to other users. The sequences may be used to determine commissions paid on various payment schemes.

In some embodiments, an analysis engine 125 may analyze the advertising database 124 to determine influence ratings for each user. The influence ratings may reflect the success of various users in sending advertisements to other users, and the results of those advertisements when the receiving user interacts with the advertisement. The output of the analysis engine 125 may be stored in an influence database 128.

An influence engine 126 may respond to queries regarding the influence of various users. The influence engine 126 may receive a query that defines a scope of users to analyze, as well as a topic for analysis. The relative influence of the users may be determined for a specific topic and a sorted list or other response may be returned.

The influence engine 126 may have a social network analyzer 130 that may determine at least a portion of the influence for each user. The social network analyzer 130 may search keywords or other information within a social network to determine how influential a particular user may be. The influence may be determined by estimating the likelihood or probability that a user may forward information on a certain topic, or how likely the user may consume information on the topic.

Depending on the type of social network, the social network analyzer 130 may analyze public content exclusively. Public content may be the content that is publically available without privacy restrictions. In some embodiments, the social network analyzer 130 may be able to access private or restricted content within the social network when users have given permission for such analysis.

The influence database 128 may contain influence information from both the social network analyzer 130 and the analysis engine 125. The analysis engine 125 may gather influence information from actual advertisements, while the social network analyzer may gather influence information from past interactions on social networks.

The architecture of a system may include user devices 134 that interact with a social network server 136 across a network 132. A merchant server 138 may be operated by a merchant or seller for which an advertisement may be created. The device 102 may perform the operations of a marketplace in the architecture of embodiment 100. The network 132 may represent a local area network, wide area network, the Internet, or any other network.

A user device 134 may have a hardware platform 140, which may be similar to the hardware platform 104 illustrated for device 102. The user device 134 may be any type of computer device that may be configured to access a social network. In some embodiments, the user device 134 may be a personal computer, server computer, game console, mobile telephone, personal digital assistant, or any other type of device.

In some embodiments, a browser 142 may be used to access a social network. In such an embodiment, the social network may have a mechanism to interface with the marketplace operating on device 102. In another embodiment, a social network application 144 may communicate with a social network server 136 to provide a social network experience. In such embodiments, a marketplace plug in 146 may be used to communicate with the marketplace of device 102. Similarly, an email application 148 may have a marketplace plug in 150 or an instant messaging application 152 may have a marketplace plug in 154.

The marketplace plug ins 146, 150, and 154 may identify advertisements that are created or received by an application and may communicate with the advertising engine 120 to request identification keys to create new advertisements, or to report receipt of advertisements. The marketplace plug ins 146, 150, and 154 may also communicate with the influence engine 126 to send queries to identify users' influence information and process the results for use in the various social network applications.

The social network server 136 may provide any type of social network, including formal or informal social networks. The social network server 136 may be illustrated as operating on a hardware platform 156, which may be similar to the hardware platform 104. In many large scale social networks, the hardware platform 156 may be a cluster of multiple computers, which may be virtualized in some cases.

Operating on the hardware platform 156 may be a social network application 158. In some embodiments, a single social network may have several different interfaces, including a web-based or HTML interface, an Application Programming Interface (API) or other type of interface.

Operating with the social network application 158 may be a marketplace connector 160. The marketplace connector 160 may communicate with the marketplace operable on device 102 to exchange advertisement information with the advertising engine 120 or to perform influence queries against the influence engine 126.

In some embodiments, the advertisements may cross multiple social networks. For example, a user may create an advertisement using a restricted access social network and post the advertisement for the user's friends to view. A friend may copy and paste the advertisement and email the advertisement to a second friend, who may in turn post the advertisement on yet another social network. At each point the advertisement may be forwarded or transmitted to another user, the social networks or the client applications accessing the social networks may communicate with the advertising engine 120 to store the transaction and update the advertisement for tracking the transactions.

A merchant server 138 may host a website or other service that may be the target or call to action of an advertisement. The merchant server 138 may operate on a hardware platform 162, which may be a cluster of computers, a single server, or other architecture. Operating on the hardware platform 162 may be a merchant application 164. In many cases, the merchant application 164 may be a website or other application. The merchant application 164 may be a destination of a link contained in an advertisement.

The merchant application 164 may have a marketplace connector 166 that may communicate with the advertising engine 120. In some embodiments, the merchant application 164 may allow a user to create an advertisement that may be used in a social network. In such an embodiment, the marketplace connector 166 may communicate with the advertising engine 120 to create an identifying key for an advertisement and register the advertisement in the advertising database 124.

When a user accesses the merchant application 164 from an advertisement, the marketplace connector 166 may communicate with the advertising engine 120. The marketplace connector 166 may send the advertisement's identification key as well as other metadata regarding the advertisement, the user, and the transaction that may occur between the user and the merchant application 164.

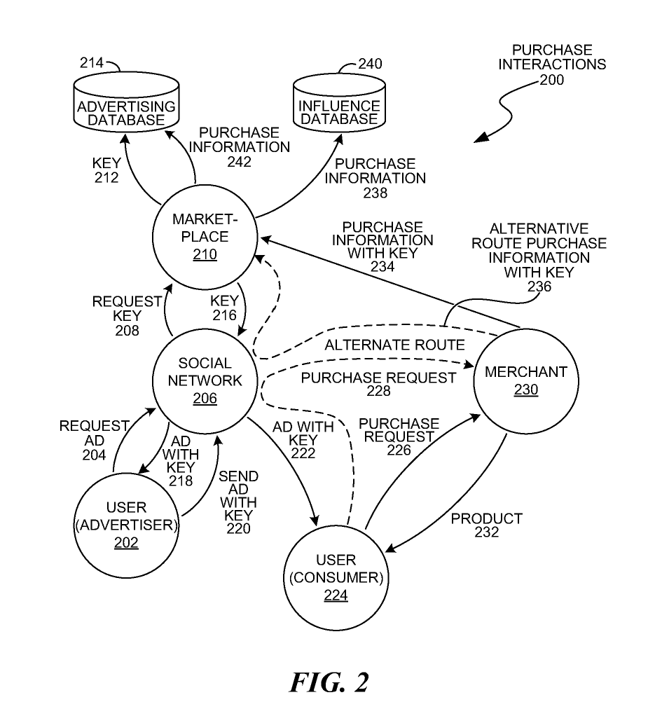

FIG. 2 is a diagram of an embodiment 200, showing interactions between different systems and users in a marketplace transaction.

Embodiment 200 may illustrate some of the transactions and sequence of transactions that may occur between users and components of the system illustrated in embodiment 100. The transactions illustrated may show the creation of an advertisement, the transmission of an advertisement through a social network to another user, and the consummation of a transaction with a merchant.

In the example of embodiment 200, one user may be classified as an advertiser 202, while a second user may be classified as a consumer 224. In some use scenarios, the advertiser 202 may be a company such as a merchant that may be selling a particular good or service. In other use scenarios, the advertiser 202 may be a user who received an advertisement from someplace and forwards the advertisement to another user.

The advertiser 202 may request an advertisement 204 from a social network 206. As part of generating an advertisement, the social network 206 may send a key request 208 to a marketplace 210.

The marketplace 210 may generate an identification key 216 and send the key 212 to be stored in the advertising database 214. The marketplace 210 may also return the key 216 to the social network 206. The social network 206 may create an advertisement 218 that has the identifying key and transmit the advertisement 218 to the user acting as the advertiser 202.

In some embodiments, the identifying key may be visible to a user, while in other embodiments, the identifying key may be hidden from the user.

The advertiser 202 may upload, post, email, or otherwise transmit the advertisement 220 with the key to the social network 206. Through the social network 206, a consumer 224 may receive the advertisement 222 that has the identifying key.

The consumer 224 may use the advertisement 222 to send a purchase request 226 to a merchant 230, and the merchant 230 may send a product 232 to the consumer 224. In some embodiments, the purchase request 228 may travel through the social network 206 to reach the merchant 230.

When the merchant 230 receives the purchase request 226, the merchant 230 may send purchase information 234 with the identifying key for the advertisement to the marketplace 210. In some embodiments, the purchase information 236 may travel through the social network 206 to reach the marketplace 210.

The marketplace 210 may update the advertising database 214 with the purchase information 242, and may also update an influence database 240 with the purchase information 238.

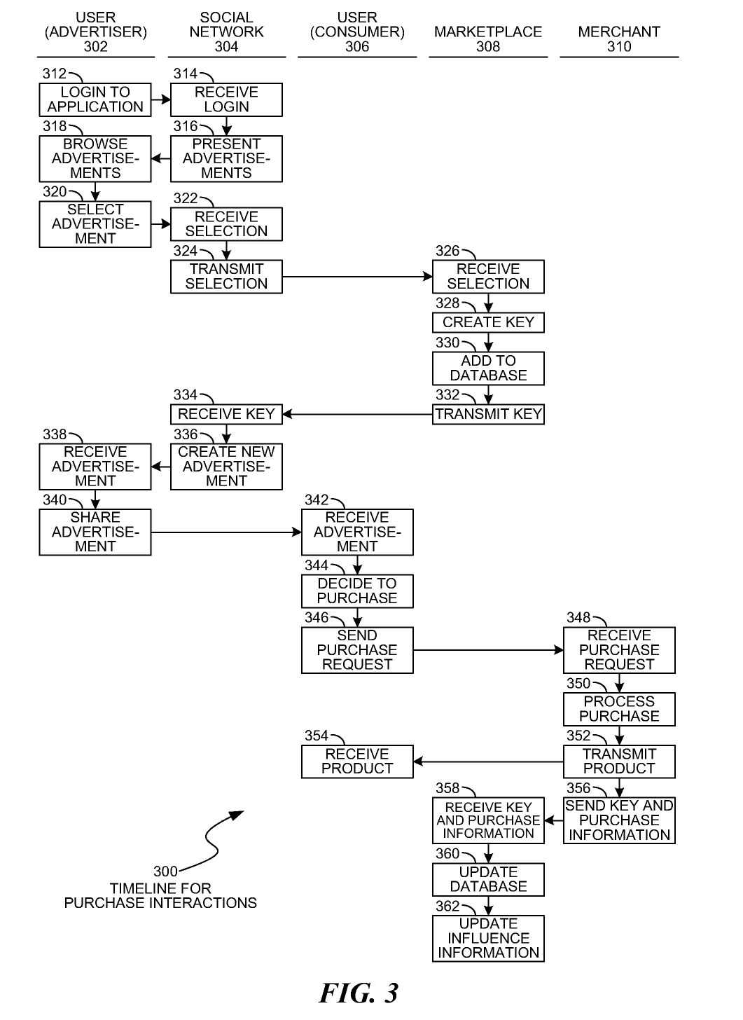

FIG. 3 is a timeline illustration of an embodiment 300 showing a method for processing purchase interactions. Embodiment 300 may be similar to the process illustrated in embodiment 200. In embodiment 300, the operations of an advertiser 302 are illustrated in the first column on the left, and the operations of a social network 304 are illustrated in the second column. The operations of a consumer 306 are illustrated in the middle column, and operations of a marketplace 308 are illustrated in the fourth column. The operations of a merchant 310 are illustrated in the fifth or right hand column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 312, an advertiser 302 may login to a social network application, which may be received in block 314 by the social network 304.

The social network 304 may present advertisements in block 316 to the advertiser 302. In some embodiments, the social network 304 may have a user interface through which a user may create or select advertisements. When creating an advertisement, the user may write text associated with an advertisement, generate graphics, or perform other creative operations to create an original advertisement.

In some embodiments, the social network may present advertisements received from other users and the advertiser 302 may browse advertisements in block 318 and select an advertisement in block 320 to post or forward through the social network 304.

The social network 304 may receive the selection in block 322 and transmit the selection in block 324 to the marketplace 308, which may receive the selection in block 326. In some embodiments, the information received in block 326 may be metadata about the advertisement. The metadata may include an identifier for the advertiser 302, as well as an identifier for the selected advertisement.

After receiving the selection in block 326, an identifier key may be created in block 328 and added to the advertisement database in block 330. The identifier key may be transmitted in block 332 to the social network 304, which may receive the identifier key in block 334. The social network 304 may create a new advertisement in block 336 that may include the identifier key.

The advertiser 302 may receive the advertisement in block 338 and may share the advertisement in block 340 through the social network 304. The method of sharing the advertisement may vary from one social network to another. In some cases, the advertisement may be transmitted onto a publically accessible forum where many different people may view the advertisement. In other cases, the advertisement may be transmitted using private or other restricted access social networks, such as through email communication or instant message communication.

The consumer 306 may receive the advertisement in block 342 and may decide to purchase or otherwise respond to the advertisement in block 344. Through the advertisement, the consumer 306 may send a purchase request in block 346 to the merchant 310, which may receive the purchase request in block 348.

The merchant 310 may process the purchase in block 350 and transmit a product in block 352 to the consumer 306, which may receive the product in block 354.

The merchant may also send the identifier key and purchase information in block 356 to the marketplace 308, which may receive the purchase information in block 358. The marketplace 308 may update an advertisement database in block 360 and update an influence database in block 362.

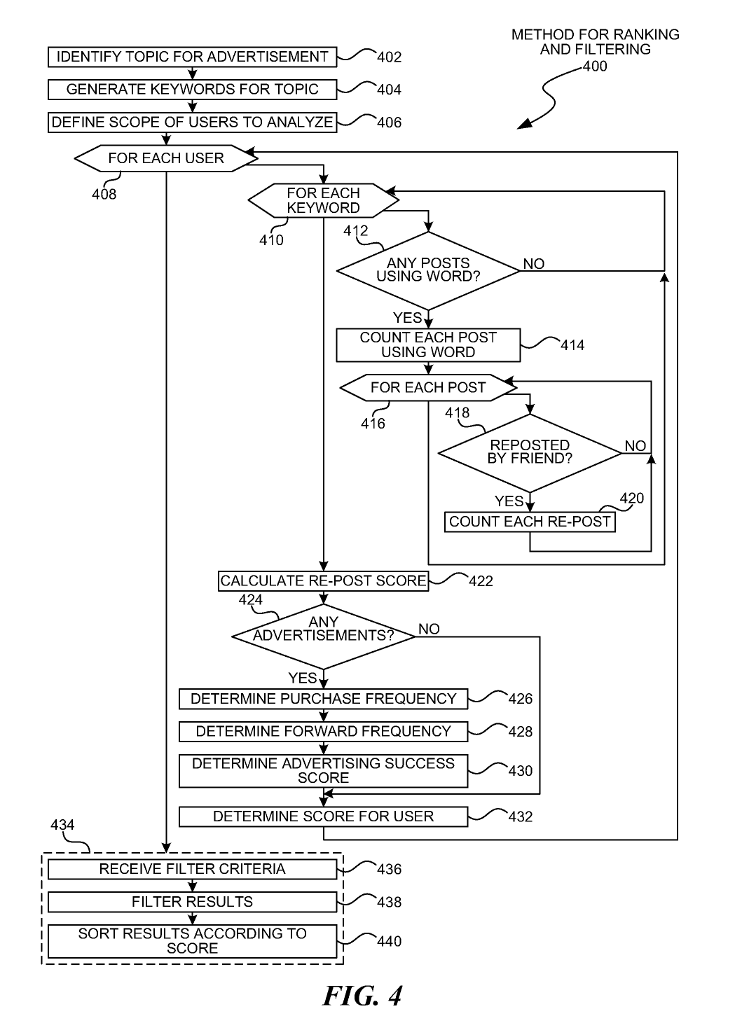

FIG. 4 is a flowchart illustration of an embodiment 400 showing a method for ranking and filtering using influence information. Embodiment 400 illustrates one method for evaluating several users' influence through social network activities and through their participation and success using the advertisement marketplace.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 may represent the activities that an influence engine may perform to determine influence information for several users. The influence information may be tailored to a specific topic.

In block 402, a topic may be identified for determining influence. In block 404, keywords related to the topic may be selected. In some embodiments, phrases may be considered keywords as well as individual words. The range of keywords may be analyzed in various users' postings on a social network to determine whether or not the user has discussed the topic and how often the user's posts were forwarded or acted upon by other people. Such statistics may be used to measure the user's influence on a specific topic.

The scope of users to analyze may be determined in block 406. The scope of users to analyze may vary from one situation to another. For a social network with private or limited access to content, the scope of users may include those users that have a first or second degree relationship to a first user. A first degree relationship may be a direct relationship between the first user and the first user's friends. A second degree relationship may be the relationship between the first user's friends and the friends of the first user's friends.

In a publically broadcast or fully accessible social network, the scope of users may be the universe of users in some cases. In other cases, the scope of users may be limited by geographic area or postings transmitted at certain times of the year or times of the day. Some embodiments may allow the scope of the users to be limited to a personal or social context. An example of a personal context may be people who are working, on vacation, travelling, at home, or other context. An example of a social context may be alone, with colleagues, with family or friends, or other context.

In some embodiments, the scope of users determined in block 406 may also be used to filter or limit the social network postings related to the topic.

Each user may be evaluated in block 408, and for each user, each keyword may be evaluated in block 410. For each keyword in block 410, if none of the user's posts contain the keyword in block 412, the process may return to block 410. If at least one of the user's post contains the keyword in block 412, each post containing the keyword may be counted in block 414.

For each of the user's posts containing the keyword in block 416, if the post was not re-posted by a friend in block 418, the process may return to block 416. If the post was re-posted in block 418, each re-post may be counted in block 420. The process may return to block 416.

After evaluating each keyword in block 410, a re-post score may be calculated in block 422. The re-post score may be calculated by dividing the total number re-posts by the total number of posts containing the keywords. Other embodiments may use different methods for calculating a re-post score.

If the user has been involved in any advertisements related to the topic in block 424, the purchase frequency may be determined in block 426 and the frequency the user forwarded advertisements may be determined in block 428. Based on the purchase frequency and forwarding frequency, an advertising success score may be calculated.

An influence score may be determined in block 432. When the advertisements are present in block 424, the advertising success score as well as the re-post score may be used to determine an influence score in block 432. If the user does not have any history with advertisements in block 424, the user's influence score may be determined by the user's interaction on the social network. The process may return to block 408 to process another user.

In some embodiments, two or more social networks may be evaluated to determine a user's influence score. In such cases, the scores may be calculated for each social network and then weighted or combined together.

The operations of block 434 may be performed by an influence engine, a social network server application, or a social network client application. In block 434, filter criteria may be received and the results may be filtered in block 436. The results may be sorted according to the score in block 440.

The filtering operations of blocks 436 and 438 may remove results that may not apply based on any type of criteria. For example, a filter may limit the results to users within a certain geographical area or apply some other criteria.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
receiving a first advertising request comprising a first user identifier;
generating a first request key in response to said first advertising request;
transmitting said first request key in response to said first advertising request;
receiving a first transaction description comprising said first request key;
updating influence data associated with said first user identifier based on said first transaction description;
receiving a first sorting request;
determining a first scope for said first sorting request, said first scope identifying a plurality of users;
determining a ranking for said plurality of users, said ranking based on said influence data; and
returning a sorted list of said plurality of users according to said ranking.

2. The method of claim 1, said influence data being determined by:
determining a re-post probability by examining interactions between users of a social network.

3. The method of claim 2, said social network being a formal social network comprising a first overt acknowledgement of a first relationship from a first user and a second user.

4. The method of claim 3, said formal social network further comprising a second overt acknowledgement of a second relationship from said second user to said first user.

5. The method of claim 2, said social network comprising an informal social network.

6. The method of claim 1, said plurality of users being determined by:
identifying a first user; and
identifying said plurality of users as those users having social network relationships with said first user.

7. The method of claim 6, said social network relationships comprising second degree social network relationships.

8. The method of claim 1 further comprising:
identifying said first transaction description as being a purchase transaction from a second user; and
determining a commission for a first user based on said purchase transaction.

9. A system comprising:
a computer processor;
an advertising engine that:
receives a first advertising request comprising a first user identifier;
generates a first request key in response to said first advertising request;
transmits said first request key in response to said first advertising request;
stores said first request key in an advertising database comprising request keys, advertisements associated with said request keys, and users associated with advertisements;
receives a first transaction description comprising said first request key;
updates influence data associated with said first user identifier based on said first transaction description;
an influence engine that:
receives a first sorting request;
determines a first scope for said first sorting request, said first scope identifying a plurality of users;
determines a ranking for said plurality of users, said ranking based on said influence data; and
returns a sorted list of said plurality of users according to said ranking.

10. The system of claim 9, said advertising engine being configured to receive said first advertising request from a social network system.

11. The system of claim 10, said social network system using a marketplace connector to communicate with said advertising engine.

12. The system of claim 11, said influence engine being configured to receive said first sorting request from said social network system.

13. The system of claim 12, said first sorting request being generated by a client plug-in for said social network system.

14. The system of claim 10, said social network generating said first sorting request when a user receives a plurality of said advertisements.

15. The system of claim 10, said social network generating said first sorting request when a user selects a plurality of users to send an advertisement.

16. The system of claim 9 further comprising:
a social network comprising a communication system that transmits communications between users.

17. The system of claim 16, said communications comprising broadcast communications transmitted to a plurality of users.

18. A method comprising:
receiving a first sorting request, said first sorting request identifying a first user, said first user being a member of a first social network;
determining a first scope for said first sorting request, said first scope identifying a plurality of users;
determining a ranking for said plurality of users by:
determining a topic for said first sorting request;
searching said first social network for communications relating to said topic;
for each of said plurality of users, determining a re-post probability being a probability that a first user's communication will be reposted by a second user; and
determining said ranking using said re-post probability;
returning a sorted list of said plurality of users according to said ranking.

19. The method of claim 18, said plurality of users being selected without regard to relationships in said social network.

20. The method of claim 18, further returning said re-post probability with said sorted list.
